(19) United States
(12) Patent Application Publication
(10) Pub. No.: US 2015/0023788 A1
(43) Pub. Date: Jan. 22, 2015

(54) FLOW THERMAL STRESS TURBOCHARGER TURBINE HOUSING DIVIDER WALL

(71) Applicant: BorgWarner Inc., Auburn hills, MI (US)

(72) Inventors: Kiumars Shoghi, Huddersfield (GB); Alexandre Garcia Alcaraz, Paulinia (BR); Claus Oberste-Brandenburg, Gau-Odernheim (DE)

(21) Appl. No.: 14/380,467

(22) PCT Filed: Feb. 21, 2013
(86) PCT No.: PCT/US2013/027037

§ 371 Date: Aug. 22, 2014

Related U.S. Application Data
(60) Provisional application No. 61/604,111, filed on Feb. 28, 2012.

(51) Int. Cl. F01D 25/24

(52) U.S. Cl. CPC F01D 25/24; F05D 2220/40; F05D 2260/16
USPC 415/208.1

(57) ABSTRACT

The propensity for turbocharger turbine divider wall to crack in the turbine housing is minimized by matching the mass of the divider wall more closely to the transient heat transfer between said divider wall and the exhaust gas flowing past it. This is achieved by providing said divider wall having a cross-sectional shape defined substantially by a Log₂ curve.

### FIELD OF THE INVENTION

This invention addresses the need for an improved turbocharger divided turbine housing design to reduce the propensity for crack initiation and propagation in the divider wall.

### BACKGROUND OF THE INVENTION

Turbochargers are a type of forced induction system. They deliver air, at greater massflow than would be possible in the normally aspirated configuration, to the engine intake, allowing more fuel to be combusted, thus boosting the engine's horsepower without significantly increasing engine weight. This can enable the use of a smaller turbocharged engine, replacing a normally aspirated engine of a larger physical size, thus reducing the mass and aerodynamic frontal area of the vehicle.

Turbochargers use the exhaust flow from the engine exhaust manifold to drive a turbine wheel (10), which is located in a turbine housing (2). Once the exhaust gas has passed through the turbine wheel, and the turbine wheel has extracted energy from the exhaust gas, the spent exhaust gas exits the turbine housing through the exducer and is ducted to the vehicle downpipe and usually to after-treatment devices such as catalytic converters, particulate traps, and NOₓ traps. The energy extracted by turbine wheel (10) is translated to a rotational motion which then drives a compressor wheel. The compressor wheel draws air into the turbocharger, compresses this air, and delivers it to the intake side of the engine.

Engine exhaust consists of a mix of steady state pressure and pulsed exhaust gas, the pulses of which can be in phase, not in phase, or time variable. The characteristics of the pulses are generally dependant upon the exhaust timing, the flow characteristics of the combustion chamber exhaust (i.e., 1 or 2 valves), and the speed of the engine. In low speed engines, these pulses can be quite distinct. In high speed engines, these pulses merge to produce predominantly near-steady-state pressure toward the high end of the speed range, but at the low end of the speed range the pulses can still be quite distinct.

Turbine housings come in several basic types: open, as depicted in FIG. 2A; meridionally divided, as depicted in FIG. 2B; and double flow. In an open turbine housing, the pulses from the exhaust manifold of the engine are allowed to mix, providing relatively steady state exhaust gas to the turbine wheel. When the pulses produced in the combustion chamber are significantly distinct, for example on low speed Diesel engines, the pulses from one part (for example the front three cylinders of a six cylinder engine) of the engine are preferably kept segregated from the pulses from the other part (in the above example, the back three cylinders of a six cylinder engine). The segregation of the pulse energy can be maintained through the exhaust manifold to the foot of the turbine housing, and the segregation can be maintained in the turbine housing by the use of a divider wall separating the volutes within the turbine housing. Typically this segregation is maintained in separate volutes all the way up to nearly the entrance of the turbine wheel.

The gap between the trailing edge of the divider wall and the entrance of the turbine wheel is typically chosen as a compromise between harnessing the greatest pulse energy from the extracted exhaust flow and minimizing excitation to the turbine wheel. Typically this gap is from 10% to 15% the diameter of the turbine wheel.

When a (meridionally) divided turbine housing is used, the pulses from engine combustion are maintained in the turbine housing, are then absorbed by the turbine wheel, and are finally converted into rotational energy, which ultimately drives the compressor stage. The energy derived from the pulses is in addition to the energy which would be absorbed if the flow was steady state, so the efficiency of the turbine stage is increased. It is also important to note that some aerodynamic designs of turbine wheels are better at converting these exhaust pulses into rotational energy than are other designs.

The design of the turbine housing plays a fundamental part in the turbine stage efficiency. Features which contribute to the efficiency of the turbine stage include: the wetted surface area (that part of the turbine housing which is wetted by the exhaust flow in the turbine volutes), the profile of the walls leading to the “nozzle”, the design of the divider wall, the positioning of the divider wall relative to the other parts of the “nozzle”, the distance of the trailing edge of the divider wall to the entrance of the turbine wheel, the shape of the trailing of the divider wall, and the A/R of the turbine housing.

Part of the physical design of the turbine housing is a volute, the function of which is to control the inlet conditions to the turbine wheel such that the inlet flow conditions provide the most efficient transfer of power from the energy in the exhaust gas to the power developed by the turbine wheel. Theoretically, the incoming exhaust flow from the engine is delivered in a uniform manner from the volute to a vortex centered on the turbine wheel axis. To do this, the cross sectional area of the volute gradually and continuously decreases until it becomes zero. The inner boundary of the volute can be a perfect circle, defined as the base circle; or, in certain cases, such as a twin volute, it can describe a spiral, of minimum diameter, not less than: from 110% to 115% of the turbine wheel diameter. The volute is defined by the decreasing radius of the outer boundary of the volute and by the inner boundary, as described above, in one plane defined in the “X-Y” axis, and the cross sectional areas, at each station, in the plane passing through the “Z” axis. The “Z” axis is perpendicular to the plane defined by the “X-Y” axis and is also the axis of the turbine wheel.

The design development of the volute initiates at slice “A”, which is defined as the angular datum for the volute. The datum is defined as the slice at an angle of “P” degrees above the “X”-axis of the turbine housing, containing the “X”-axis, “Y”-axis and “Z”-axis details of the volute shape.

The size and shape of the volute is defined in the following manner: The widely used term A/R represents the ratio of the partial area at slice “A” divided by the distance from the centroid of the shaded flow area (110) to the turbo centerline. In FIGS. 2A and 2B, representing an open turbine housing and a divided turbine housing respectively, the centroids (112, 113) determine the distance R_{A} and R_{B} to the turbo centerline. For different members of a family of turbine housings, the general shape remains the same, but the area at slice “A” is different, as is the distance R_{A}. The A/R ratio is generally used as the “name” for a specific turbine housing to differentiate that turbine housing from others in the same family (with different A/R ratios). In FIG. 2A, the volute is that of a reasonably circular shape. In FIG. 2B, the volute is that of a divided turbine housing which forces the shape to be generally triangular. Although the areas at slice “A” for both volutes are the same, the shapes are different and the radii to the centroids are different (due to the volute shape), so the A/Rs will be different. Slice “A” is offset by angle “P” from the “X”-axis. The turbine housing is then geometrically split into equal radial slices (often 30°, thus at [30x+P]°), and the areas and the radii along with other geometric definitions, such as corner radii, are defined. From this definition, splines of points along the volute walls are generated thus defining the full shape of the volute. The wall thickness is added to the internal volute shape, and, through this method, a turbine housing is defined.

The theoretically optimized volute shape for a given area is that of a circular cross-section since it has the minimum surface area which minimizes the fluid frictional losses. The volute, however, does not act on its own but is part of a system; so the requirements of flow in the planes from slice “A” to the tongue influence the performance of the turbine stage. These requirements often result in compromises such as architectural requirements outside of the turbine housing, method of location, and mounting of the turbine housing to the bearing housing, and the transition from slice “A” to the turbine foot (7) results in turbine housing volutes of rectangular or triangular section, as well as in circular, or combinations of all shapes.

Some parts of the volute, as depicted in FIG. 4, which have an effect on the flow and thus the efficiency of the turbine housing part of the turbine stage, are: the roof of the volute (13); the surface (19) of the divider wall (16); the trailing edge, or tip (21) of the divider wall; the outer wall of the volute (23); the inner wall of the volute (22); the radius (15) between the surface (19) of the divider wall (16) and the roof (13) of the volute; the radius between the roof (13) of the volute and the outer wall (22); the flow area (25) between the transition of the divider wall (16) to the trailing edge or tip (21) of the divider wall; the side walls (22, 23) as they near the trailing edge or tip of the divider wall; and the shape and position of the side wall as it enters the turbine wheel leading edge.

With the aerodynamic sensitivity of the various parts, which contribute to the volute in mind, the shapes of various segments of the divider wall are also of importance.

Since the divider wall is part of an aerodynamic device, the trailing edge (21) should be as sharp as possible (as, for example, the trailing edge of a wing). While this design facet provides efficient aerodynamics (the flow off the trailing edge does not become turbulent as the flow from one side of the divider wall attaches itself to the flow from the other side), the thin section around the intersection of the two sides of the trailing edge makes this area very susceptible to cracking. Typically the inner bound of the divider wall is set at a particular radius (18) from the turbocharger axis (1). The as-cast shape of the trailing edge of the divider wall is typically that of a parabola, or a radius plus spline, either of which is tangential to the generally radial outer surface (19) of the divider wall.

A problem with this part of the turbine housing is that when molten iron is poured into a sand mold, the dross (which is a form of slag) from a reaction of the molten cast iron with Mg, O₂, S, and Si is pushed into the trailing edge part of the divider wall. The dross formations resemble cracks or flake graphite in the structure, which means that the part of the turbine housing closest to the turbine wheel has low impact and fatigue strength, which can result in foreign object damage (FOD) to the turbine wheel. As a result of this metallurgical situation, the trailing edges tend to be designed thicker than aerodynamically desirable.

The thickness of the divider wall is an intrusion into the volume of the volute, which means that for a divided turbine housing with the same volute cross sectional area as that of an open (i.e., non-divided) turbine housing, the outside surfaces must be larger than is the case with an open turbine housing. As a result of this, many divider walls are parallel, or nearly parallel as depicted in FIGS. 1 and 4, but in any case have primarily planar surfaces. The example depicted in FIG. 4 is that of a parallel divider wall with a parabolic trailing edge.

The aerodynamic interaction of the lower (i.e., that part closer to the divider wall trailing edge (21) than to the roof of the volute) part of the divider wall and the side walls (22 and 23) of the volute, and, in particular, the interaction between the trailing edge (21) of the divider wall and the lower part (24) of the exducer-side sidewall (23), typically called the exducer throat, forms an aerodynamic “nozzle” which has a great effect on the flow into the turbine wheel (10).

While the design of the elements of a turbine housing volute may be exact to +/−0.02 of a millimeter, in the manufacturing process, there are several steps which cause the variation to be larger.

Since the typical cast iron turbine housing is cast into a sand mold, the process of building the mold out of a “cope” and “drag”, each of which are formed from opposite sides of a pattern, along with the insertion of cores where applicable, results is some lack of alignment with each other, known as core shift, which results in inaccuracy in the cast part. Another source of inaccuracy is the fact that the mold is typically made from green foundry sand, which has a grain size of approximately 220 μm to 250 μm, so not only is there inherent inaccuracy between parts of the mold, but also in the surface finish. The typical foundry accuracy for parts such as turbine housings is from 0.7 mm to 1.5 mm

The heat field within a turbine housing is angularly and radially uneven. In an angular sense, the hottest part is at the turbine foot, where the exhaust gas enters the turbine housing; the temperature cools as the volute diminishes towards the tongue. In a radial sense, the temperature increases as the exhaust gas flows toward the wheel from the roof of the volute. As a result of these disparities, the tendency of the turbine housing under thermal stress is for the volute to unwind. Graphically, the turbine housing is coiled like a snail shell and the thermal forces tend to make the snail shell try to unwind. The divider wall, along with the side walls, constrains the volute from unwinding. The sidewalls are connected to high mass hoops which tend to constrain them from unwinding. The divider wall of a divided turbine housing, while constrained at its largest diameter in that it is joined to the volute wall, is unconstrained at its inner diameter and is tapered towards that minimum diameter; so that is where the thermal stresses can apply tensile loads, which manifest themselves as generally radial cracks. Further, because the divider wall has lower thermal mass than do the other generally parallel walls, the divider wall both heats and cools more rapidly; which generates greater low cycle fatigue in the divider wall and hence the propensity for cracking.

FIG. 3 depicts an end-elevation section view of a divider wall in which the turbine housing is cut perpendicular to the turbocharger axis to reveal the divider wall. The divider wall is not cut for the view. The cracks (20) are typical cracks which occur when the turbocharger, and specifically the turbine housing, is subjected to an accelerated heating and cooling cycle test designed to exacerbate the effect of such temperature excursions. These cracks are cracks which are typically seen in field-run turbochargers, validating the accelerated test results. In this test, the exhaust gas temperatures into the foot of the turbine housing are varied from 200° C. to 800° C., with very pronounced change of temperature from one extreme to the other, held first at one extreme temperature, and then back to the other extreme temperature, where it is held at temperature again. A 10 minute cycle is repeated a number of times, and then the turbine housing is checked for cracks.

Typically turbine housings are cast in either ductile cast iron or high-silicon-molybdenum (HSM) cast iron, the choice of material being dependant on the exhaust gas temperature or on the characteristic of the temperature cycle the turbine housing will see. For higher temperatures, cast irons with increased nickel alloys, such as Ni-Resist and stainless steels, are often used; but often these alloys have less elongation than does HSM, so the propensity for divider wall cracking increases.

So it can be seen that there exists the need for a better design of the divider wall in a divided turbine housing which would minimize the propensity for divider wall cracking.

### SUMMARY OF THE INVENTION

Traditionally, considering the aerodynamic function of the divider wall to segregate the exhaust gas pulses in the separate volutes (111) and to support the trailing edge (21) surfaces, the designing of the divider wall has been left in the hands of the aerodynamics designer. As a result, the outer surfaces (19) of the divider wall are generally designed parallel to each other, and sometimes they are designed as straight lines of a “V” convergent in the direction of the trailing edge of the divider wall. In any case, the mass distribution in the divider wall is generally linear since both surfaces of the sides of the divider wall are linear.

The inventors set about to improve the durability of the divider wall by designing the divider wall from a thermodynamic rather than purely aerodynamic vantage point. The inventors studied a variety of divider wall shapes based on different definitions of curves in the development of this invention and discovered that it is in fact possible to design a divider wall in a turbine housing of a turbocharger more able to resist the propensity for cracking.

The inventors discovered that, quantitatively, thermal energy is exponentially being passed to the exhaust gas, so the transient heat transfer from the divider wall is an exponential function, while the mass of the divider wall is a linear function. The inventors came to realize this mismatch, and set out to design a divider wall such that the mass of the divider wall and the transient heat transfer from the divider wall were more suitably matched.

As depicted in FIG. 5, the surfaces (44) of the central part of the divider wall are designed as Log₂ curves about the longitudinal, generally radial, axis (26) of the divider wall (16). The Log₂ curve is tangential to the root radius (14), which tangent is at the intersection of the surface (44) of the inventive divider wall and the roof (13) of the volute. Preferably the Log₂ curve also intersects the radial axis (26) of the divider wall at the intersection of the inside diameter bound (18) of the divider wall and the axis (26) of the divider wall. Preferably, the shape of the trailing edge part (21) of the divider wall is defined within the definition of the shape of the surfaces of the sides (44) of the divider wall. In other cases, the trailing edge of the inventive divider wall may be designed as a parabola, a radius, or a spline plus a radius, in which case the inventive Log₂ curve would be tangential to the definition of the trailing edge. The inner bound of the trailing edge would still be defined by the radius from the central axis (1) of the turbocharger to the trailing edge (18).

### BRIEF DESCRIPTION OF THE DRAWINGS

The present invention is illustrated by way of example and not limitation in the accompanying drawings in which like reference numbers indicate similar parts, and in which:

FIG. 1 depicts a section for a the turbine housing end of a turbocharger;

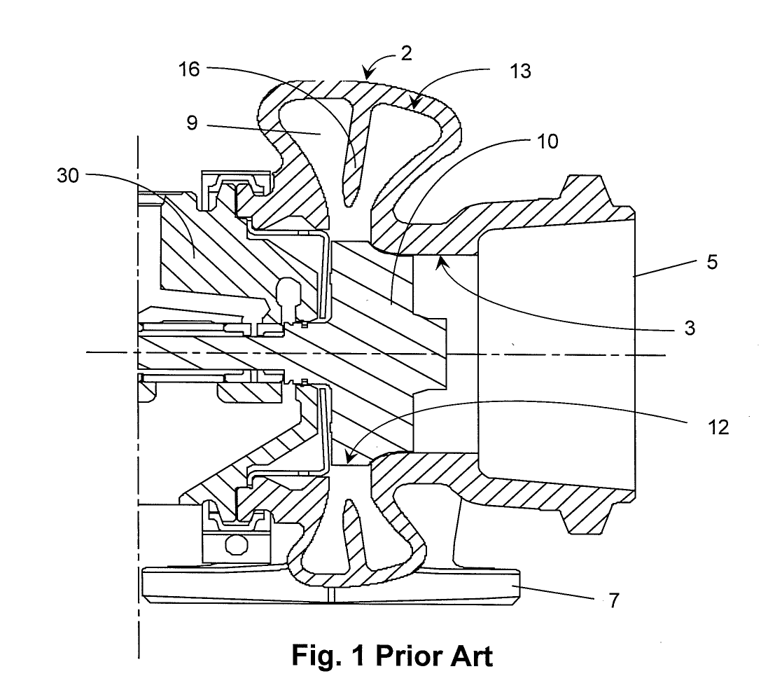

FIGS. 2A,B depict section views of volutes;

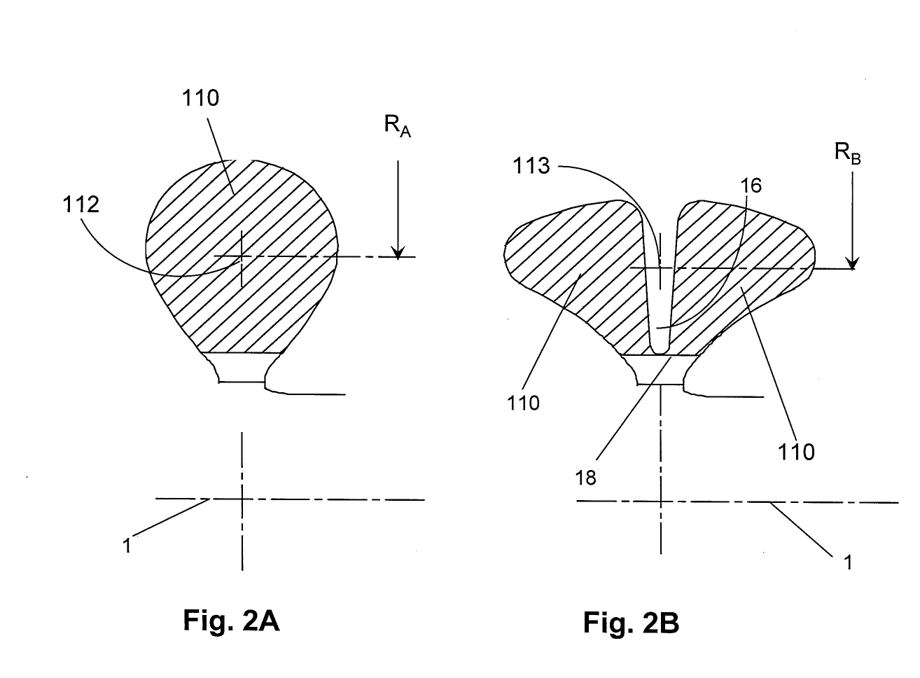

FIG. 3 depicts a an exposed divider wall showing typical cracks;

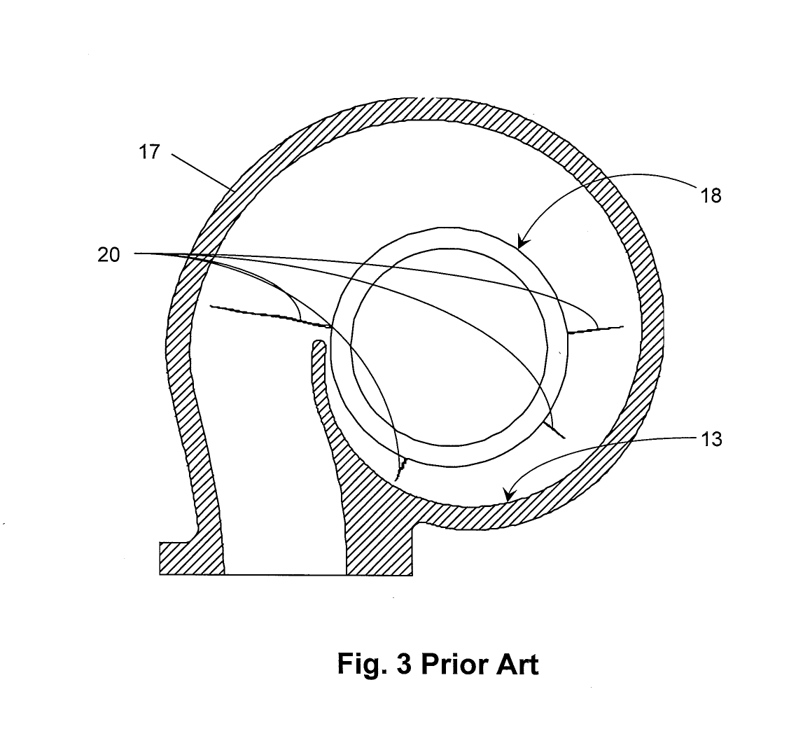

FIG. 4 depicts a section view of a prior art divider wall and volute;

FIG. 5 depicts a section view of the inventive divider wall and volute;

FIG. 6 depicts construction of several divider wall profiles; and

FIG. 7 depicts a magnified view showing the bounds of divider wall envelope.

### DETAILED DESCRIPTION OF THE INVENTION

Divided turbine housings in turbochargers are used to sustain, in the turbine, the pulse energy originating from low engine speed combustion in the cylinder head. The exhaust pulses are propagated along the exhaust manifold, and upon reaching the turbine the divided turbine housing further maintains the pulses to deliver pulsed flow, as against steady state flow, to the turbine wheel. This pulse energy is then converted to rotational energy by the turbine wheel.

In an aerodynamic sense, the shape of the divider wall near the trailing edge (21) and the shape of the surface of the outer walls (22, 23) of the volute form a nozzle to guide the exhaust flow into the turbine wheel (10). As a result of this aerodynamic need, the design of the divider wall, the function of which is to segregate the pulses in the separate volutes (111) and to support the trailing edge (21) surfaces, has historically been left in the hands of the aerodynamics designers. The inventors and set about to improve the durability of the divider wall by taking a different approach—by designing a divider wall from a thermodynamic vantage point.

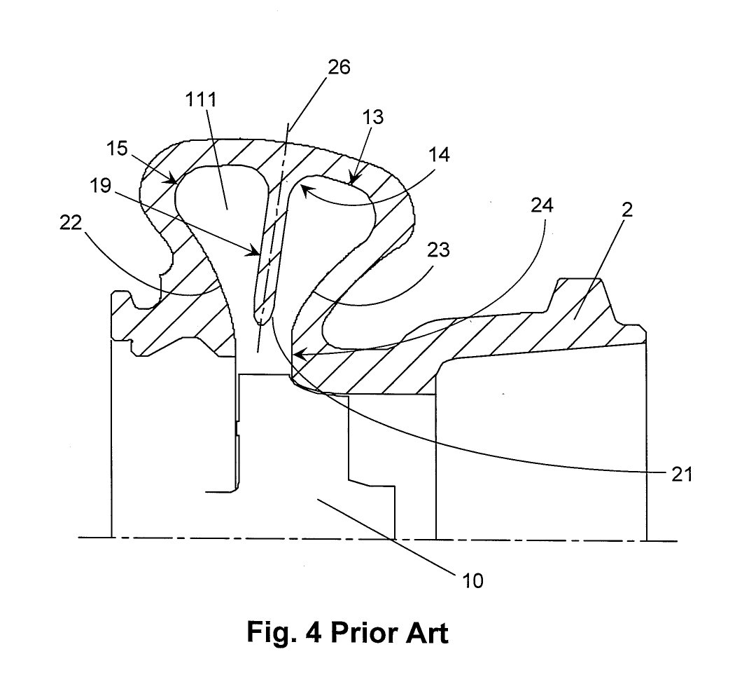

Typically, as illustrated in FIG. 4, the divider wall is a generally parallel wall structure, terminating at one end in a curve defining the trailing edge (21) of the divider wall, and at the other end in a curve defined by a root radius (14) between the roof (13) of the volute and the potentially intersecting surface (19) of the divider wall (16). Sometimes the outer surfaces (19) of the divider wall are designed parallel to each other; and sometimes they are designed as straight lines of a “V” convergent in the direction of the trailing edge of the divider wall. Generally, no matter the design of the divider wall, there will always exist both a mass difference and a thermodynamic mismatch between the divider wall and the outer walls of the volute.

Conventionally, the mass distribution in the divider wall is generally linear since both surfaces of the sides of the divider wall are linear. Quantitatively, thermal energy is exponentially being passed to the exhaust gas, so the transient heat transfer from the divider wall is an exponential function, while the mass of the divider wall is a linear function. The inventors came to realize this mismatch, and set out to design a divider wall such that the mass of the divider wall and the transient heat transfer from the divider wall were more suitably matched.

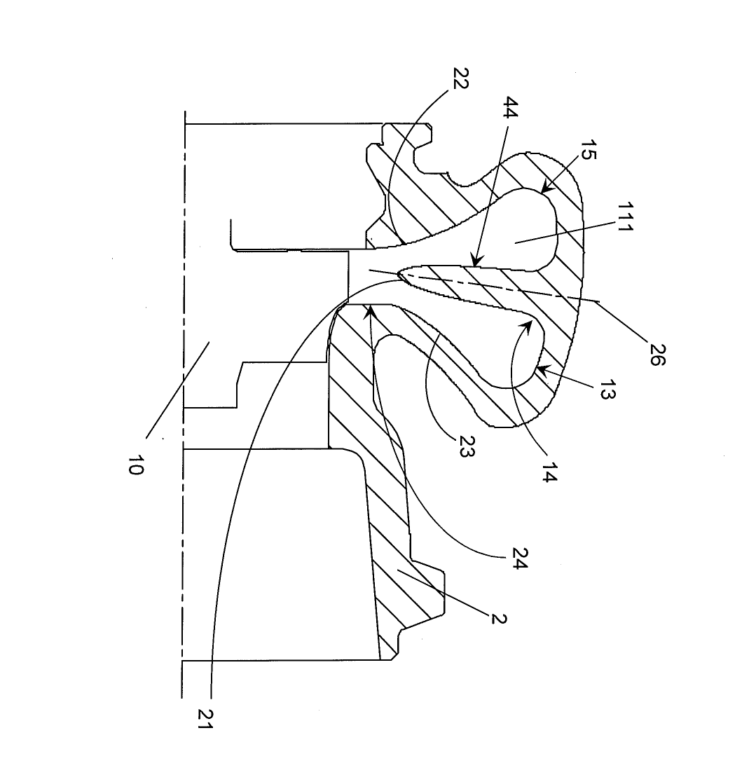

In a first embodiment of the invention, as depicted in FIG. 5, the surfaces (44) of the central part of the divider wall are designed as Log₂ curves about the generally radial axis (26) of the divider wall (16). The Log₂ curve is tangential to the root radius (14), which is at the intersection of the surface (44) of the inventive divider wall and the roof (13) of the volute. In the preferred case of the inventive divider wall, the Log₂ curve also intersects the radial axis (26) of the divider wall at the intersection of the inside diameter bound (18) of the divider wall, and the axis (26) of the divider wall. In the preferred case, the shape of the trailing edge part (21) of the divider wall is defined within the definition of the shape of the surfaces of the sides (44) of the divider wall. In other cases, the trailing edge of the inventive divider wall may be designed as a parabola, a radius, or a spline plus a radius, in which case the inventive Log₂ curve would be tangential to the definition of the trailing edge. The inner bound of the trailing edge would still be defined by the radius (18) from the central axis (1) of the turbocharger.

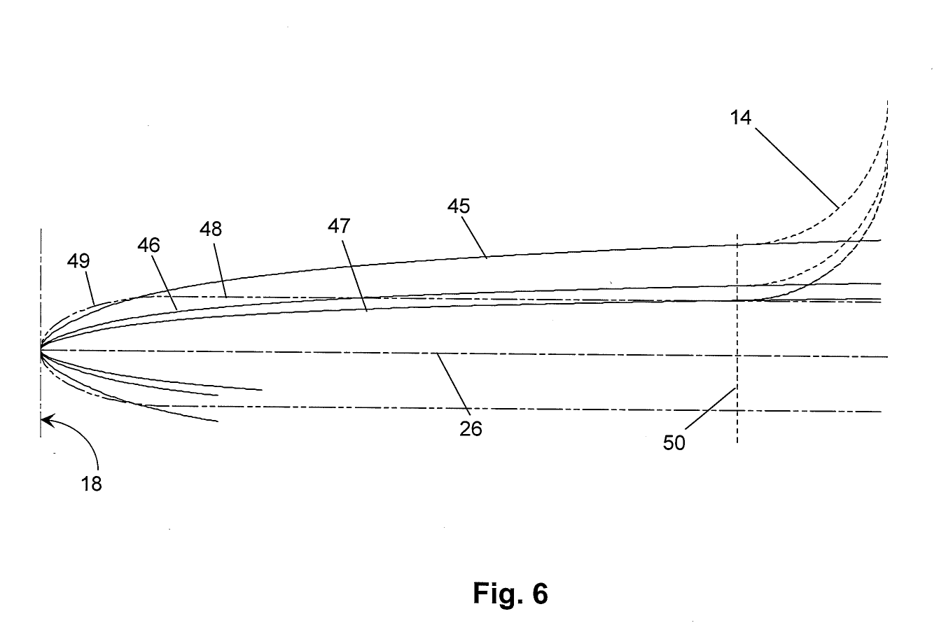

The inventors studied several divider wall shapes based on different definitions of curves in the development of this invention. As depicted in FIG. 6, the prior art divider wall is defined by a parabolic trailing edge (49), which is tangential to a pair of surfaces (48) which are parallel to each other. The inventors studied divider walls with non-parallel side surfaces, i.e., Log₃ curves (46), Log₄ curves (47) and the Log₂ curves (45), all of which are depicted in FIG. 6, before discovering that a significant improvement in resistance to crack initiation and propagation in the divider wall could be ensured with divider walls having the shape of a Log₂ curve.

Each of the alternatives depicted in FIG. 6 have an inner bound, at the aforementioned radius (18), which radius is determined as a predetermined ratio of the turbine wheel diameter, and an outer bound, which is determined by the intersection of the particular definition of the curves (46, 47, or 48) of the divider wall (16) and the root radii (14) connecting said curves (46, 47, or 48) with the roof (13) of the volute. Thus, the length/bounds of the outer surface (44) of the inventive divider wall are determined.

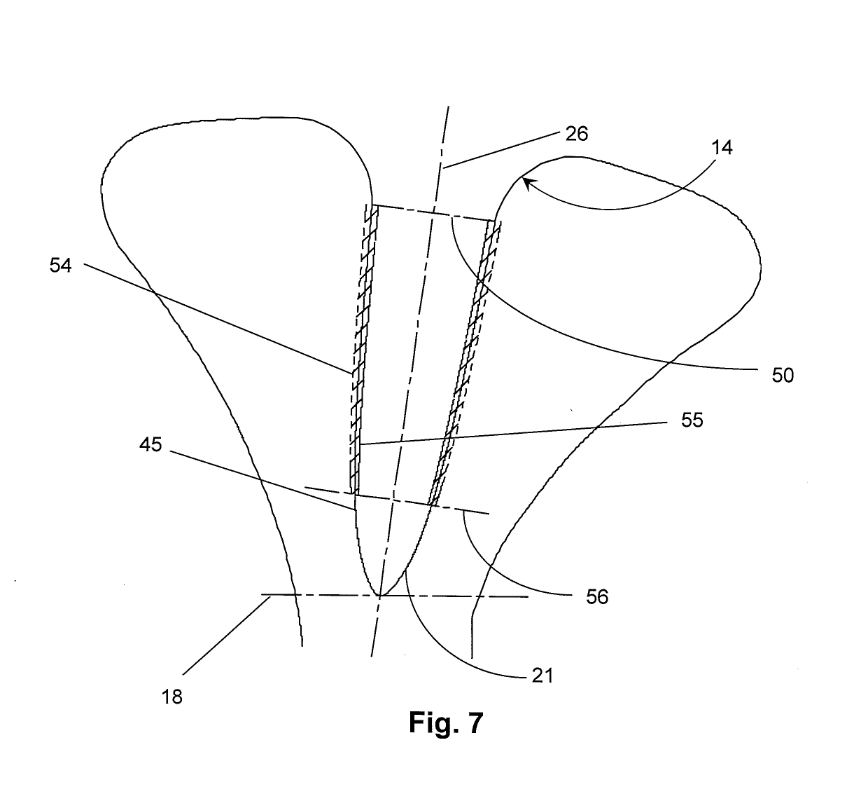

Because the exactness of the surfaces of the sides of the inventive divider wall (44) relative to a perfect shape is deteriorated by the manufacturing process, as a practical matter, a manufacturing bound of +/−10% in a generally axial displacement of the designed outer surface (44) of the divider wall is acceptable within the definition of the invention (i.e., plus 5% of total wall thickness per side=10%; minus 5% of total wall thickness per side also=10%). As depicted in FIG. 7, the widened displacement of the designed outer surface (design thickness plus 5% per side) is depicted as the curve (54), and the narrowed displacement of the designed surface (design thickness minus 5% per side) is depicted as the curve (55).

The generally radial bound of the wider displaced surface (54) is defined as: The generally radial outer bound of the inventive surface is the intersection of the root radius (14) of the surface of the roof (13) of the volute, with the larger displacement of the designed outer surface (54). The generally radial inner bound of the inventive surface is the intersection of the larger displacement of the designed outer surface (54) and a line (56) representing 25% of the generally axial length from the intersection of the root radius (14) with the larger displacement of the designed surface (54), and the intersection of the generally radial axis (26) of the divider wall with the defined above inner bound (18) of the trailing edge of the divider wall.

The generally radial bound of the smaller displaced surface (55) is defined as such: The generally radial outer bound of the inventive surface is the intersection of the root radius (14) of the surface of the roof (13) of the volute with the smaller displacement of the designed outer surface (55). The generally radial inner bound of the inventive curve is the intersection of the smaller displacement of the designed outer surface (54) and a line (56) representing 25% of the generally axial length from the intersection of the root radius (14) with the smaller displacement of the designed surface (55), and the intersection of the generally radial axis (26) of the divider wall with the defined above inner bound (18) of the trailing edge of the divider wall. A section of the annuli representing the aforementioned sectional bounds thus defined are depicted as the shaded areas in FIG. 7.

1. A turbine housing of a turbocharger, comprising a housing having a housing axis and configured to house a rotatably mounted turbine wheel and having defined therein a volute disposed around the housing axis and adapted for discharging exhaust gas to the turbine wheel, wherein the volute is meridionally divided by a dividing wall, forming first and second volute passages, said divider wall having a cross-sectional shape defined substantially by a Log₂ curve.

2. The turbine housing as in claim 1, wherein the divider wall has a length L measured from the roof (13) of the volute to the trailing edge (18) of the volute, and wherein the cross-section of at least 50% the length of the divider wall L is defined substantially by a Log₂ curve.

3. The turbine housing as in claim 1, wherein the divider wall has a length L measured from the roof (13) of the volute to the trailing edge (18) of the volute, and wherein the cross-section of at least 65% the length of the divider wall L falls is defined substantially by a Log₂ curve.

4. The turbine housing as in claim 1, wherein the divider wall has a length L measured from the roof (13) of the volute to the trailing edge (18) of the volute, and wherein the cross-section of at least 75% the length of the divider wall L is defined substantially by a Log₂ curve.

5. The turbine housing as in claim 1, wherein the divider wall has a length L measured from the roof (13) of the volute to the trailing edge (18) of the volute, and wherein the cross-section of at least 50% the length of the divider wall L falls within an envelope defined by a Log₂ curve ±5% on each side.

6. The turbine housing as in claim 1, wherein the divider wall has a length L measured from the roof (13) of the volute to the trailing edge (18) of the volute, and wherein the cross-section of at least 65% the length of the divider wall L falls within an envelope defined by a Log₂ curve ±5% on each side.

7. The turbine housing as in claim 1, wherein the divider wall has a length L measured from the roof (13) of the volute to the trailing edge (18) of the volute, and wherein the cross-section of at least 75% the length of the divider wall L falls within an envelope defined by a Log₂ curve ±5% on each side.

8. The turbine housing as in claim 1, wherein the divider wall cross-sectional shape is symmetric about a divider wall longitudinal axis.

9. A turbocharger apparatus comprising a compressor cover, a compressor wheel mounted for rotation in the compressor cover, a turbine housing, a turbine wheel mounted for rotation in the turbine housing, a combustion air inlet for enabling air to be conducted to the compressor, a combustion air outlet for enabling air from the compressor to be conducted to an engine, an the exhaust manifold for conducting exhaust gases from the engine to the turbine wheel in order to rotate the turbine wheel, the exhaust manifold being divided into at least two conduits for prevention of exhaust interference between cylinders, wherein a turbine volute is internally divided by a divider wall for maintaining continuity with outlet flow paths of the exhaust manifold conduits before the exhaust gases are conducted to the turbine, said divider wall having a cross-sectional shape defined substantially by a Log₂ curve.
